(19) United States
(12) Patent Application Publication
(10) Pub. No.: US 2005/0267995 A1
(43) Pub. Date: Dec. 1, 2005

(54) Facilitating system management functionality via interaction between hardware domains

(75) Inventors: Karl Rasmussen, Austin, TX (US); Brian A. Franklin, Austin, TX (US); Kenneth S. Goss, Austin, TX (US)

Correspondence Address: Raymond M. Galasso;Simon, Galasso & Frantz PLC, P.O. Box 26503, Austin, TX, 78755-0503, US

(73) Assignee: NEWISYS, INC.

(21) Appl. No.: 10/835,257

(22) Filed: Apr. 29, 2004

(51) Int. Cl. G06F 12/00

(52) U.S. Cl. 709/250

(57) ABSTRACT

A computer system comprises an platform hardware domain coupled to a service processor hardware domain. An information passing arrangement provided between the hardware domains is configured for enabling information to be transferred between the service processor hardware domain and the platform hardware domain. The service processor hardware domain includes a first physical layer network device and the operating platform hardware domain includes a second physical layer network device, thus providing a network interface for a respective one of the hardware domains and enabling asynchronous transfer of information between the hardware domains. The information passing arrangement includes a translation routine for translating information from a format interpretable within the service processor hardware domain to a format interpretable within the hardware domain, and for formatting the information into a message having a transmission protocol enabling message transmission over one of the hardware domain network interface.

### FIELD OF THE DISCLOSURE

The disclosures made herein relate generally to computer systems and, more particularly, to facilitating system management functionality via interaction between a plurality of hardware domains in a computer system.

### BACKGROUND

Modern advanced servers in a computer system have system management hardware and software (i.e., system management elements) for enabling system management functionality in the computer system. Examples of such system management functionality include monitoring of a present condition of system components (e.g., processors temps, processor voltages, fan speeds, etc.) of the computer system. For improved system management functionality, it is desirable for applications in a systems management hardware domain of the server to be able to interact with platform hardware domain components (e.g., software such as BIOS or SNMP) of the computer system. In one example, the platform hardware domain is the part of a server on which an operating system runs.

Conventional servers exhibit one or more limitations with respect to facilitating such system management functionality via interaction between hardware domains of the computer system. One limitation is that conventional servers often require machine-specific alterations for enabling monitoring of system components via relatively low-level system management hardware. Another limitation is that system management software in conventional servers is limited in its ability to communicate with and/or enact control over platform hardware domain components of the server. Still another limitation is that BIOS in conventional servers is generally only capable of exporting single-byte POST (Power-On Self Test) codes to indicate progress or problems. For one reason, this is because BIOS runs in an environment that is severely limited in terms of interaction/communication resources. Accordingly, even though BIOS participates in low-level testing and configuration of a machine and forms an important component in the management and monitoring of a server, the POST code mechanisms are only capable of providing a limited perspective on the state of the system components within the server. Yet, another limitation is that some systems management solutions have BIOS exchange messages with a single monitoring application using a proprietary protocol. That approach requires a second tier of communication if other applications need to be aware of BIOS status, or need to communicate configuration choices to BIOS.

Therefore, facilitating system management functionality via interaction between hardware domains of a computer system in a manner that overcomes limitations associated with conventional approaches facilitating system management functionality would be useful and novel.

### SUMMARY OF THE DISCLOSURE

Embodiments of the inventive disclosures made herein are comprised by methods and/or equipment configured for facilitating information transfer between a plurality of hardware domains within a computer system.

In one embodiment, a computer system comprises a service processor domain, a platform hardware domain communicatively coupled to a service processor hardware domain, and an information passing arrangement provided between the service processor hardware domain and the platform hardware domain. The information passing arrangement is configured for enabling information to be transferred between the service processor hardware domain and the platform hardware domain. The information passing arrangement includes a plurality of buffering devices coupled between the service processor hardware domain and the platform hardware domain. A first one of the buffering device is configured for buffering information to being transmitted from the service processor hardware domain for reception by the platform hardware domain. A second one of the buffering device is configured for buffering information being transmitted from the platform hardware domain for reception by the service processor hardware domain. The service processor hardware domain includes a first physical layer network device and the operating platform hardware domain includes a second physical layer network device. The first and second physical layer network devices each provide a network interface for a respective one of the hardware domains, thereby enabling asynchronous transfer of information between the hardware domains. The information passing arrangement includes a translation routine configured for translating information from a format interpretable within the service processor hardware domain to a format interpretable within the platform hardware domain. The translation routine is further configured for formatting the information into a message having a transmission protocol enabling transmission of the message over the network interface of one of the hardware domains.

In another embodiment, a method for facilitating information transfer between a plurality of hardware domains within a computer system comprises translating information within a local hardware domain to a format interpretable by a remote hardware domain from a format native to the local hardware domain, queuing the information in a buffering device of the local hardware domain after performing the translating and then transmitting the information from the buffering device of the local hardware domain for reception by the remote hardware domain after queuing the information. Preferably, the method further comprises formatting the information into a message having a transmission protocol enabling transmission of the message over a network interface of one of the hardware domains.

Accordingly, it is a principal object of the inventive disclosures made herein to provide methods and equipment that enable enhanced and advantageous transfer of information between hardware domains within a computer system.

It is another object of the inventive disclosures made herein to provide the capability to asynchronously transfer information between the two independent hardware domains by doing simple register accesses within two distinct buffering devices using data available and acknowledge interrupts.

Still another object of the inventive disclosures made herein is to translate the information to a protocol interpretable by a BIOS of an platform hardware domain in response to determining that the information is intended to be transmitted for reception by the BIOS of the platform hardware domain.

Still another object of the inventive disclosures made herein is to format the information for initiating a system action within the platform hardware domain.

Still another object of the inventive disclosures made herein is to enable transmission of the information by formatting the information as a message having a well-established protocol for supporting transmission of via a network interface.

These and other objects of the inventive disclosures made herein will become readily apparent upon further review of the following specification and associated drawings.

### BRIEF DESCRIPTION OF THE DRAWINGS

FIG. 1 depicts an information passing arrangement configured for enabling the transfer of information between a plurality of independent hardware domains in a computer system.

FIG. 2 depicts a computer system configured for facilitating transfer of information between a plurality of independent hardware domains in the computer system.

### DETAILED DESCRIPTION OF THE DRAWINGS

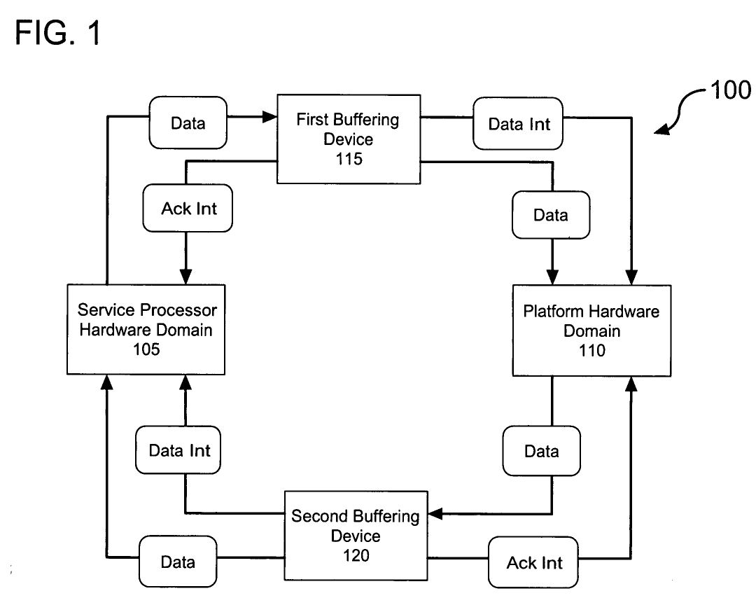

FIG. 1 depicts an information passing arrangement 100 (i.e., an infrastructure) configured for enabling transfer of information between a plurality of independent hardware domains in a computer system (e.g., a system comprising a server). The arrangement 100 includes a service processor hardware domain 105, an platform hardware domain 110 and a plurality of buffering devices (115, 120) connected between the service processor hardware domain 105 and the platform hardware domain 110. The service processor hardware domain 105 includes hardware that enables service processor functionality. The platform hardware domain 110 includes hardware that enables platform functionality.

A first buffering device 115 enables information (e.g., data) to be transmitted from the service processor hardware domain 105 for reception by the platform hardware domain 110. A second buffering device 120 enables information (e.g., data) to be transferred from the platform hardware domain 110 for reception by the service processor hardware domain 105. Each one of the buffering devices operates in accordance with Data Available interrupts and Acknowledge interrupts. It will be appreciated that such a use of a plurality of buffering devices enables asynchronous transfer of information between the plurality of independent hardware domains through simple register accesses within the buffering devices. In one embodiment, the buffering devices are First-In, First-Out buffers.

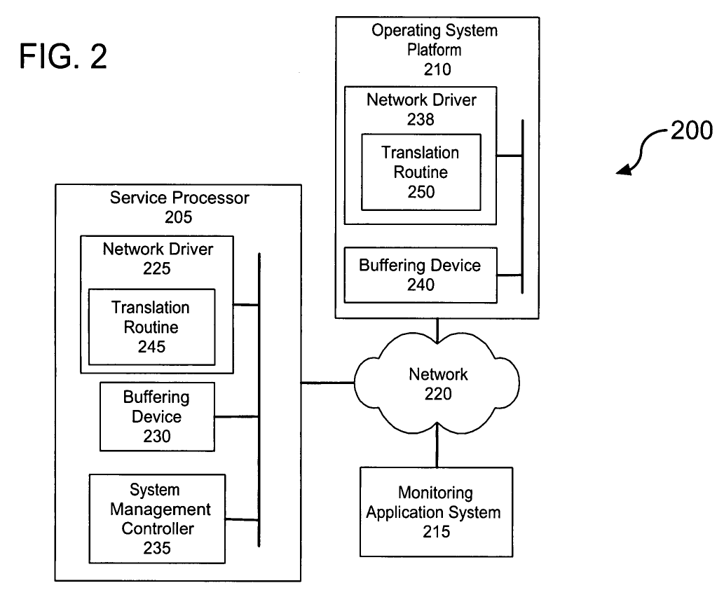

FIG. 2 depicts a computer system 200 comprising a service processor 205, an operating system platform 210 (e.g., the part of a server on which an operating system runs), a monitoring application system 215 and a network 220. The network 220 is coupled between the service processor 205, the operating system platform 210 and the monitoring application system 215 for enabling interaction therebetween and supporting system management functionality. The Internet and a local area network are examples of the network 220. System components configured for supporting operation of an operating system is an example of the operating system platform 210. A desktop computer running monitoring applications that interpret, analyse and facilitate display of system management information provided by the service processor 205 is an example of the monitoring application system 215. In one example, a server comprises the service processor 205 and the operating system platform 210.

The service processor 205 includes a network driver 225, a buffering device 230 and a system management controller 235. The operating system platform 210 includes a network driver 238 (i.e., a physical layer network driver) and a buffering device 240. The system management controller 235 is configured for facilitating system management functionality in accordance with embodiments of the inventive disclosures made herein. Examples of such system management functionality include monitoring operating parameters (i.e., fans speeds, CPU voltages, CPU temperatures, etc) and issuing commands for initiating actions within the operating system platform. Within the service processor 205, the network driver 225 (i.e., a physical layer network driver), the buffering device 230 and the system management controller 235 are interconnected for enabling interaction therebetween. Within the operating system platform, the network driver 238 and the buffering device 240 are interconnected for enabling interaction therebetween.

Each one of the network drivers (225, 238) includes a respective translation routine (245, 250) configured for providing information translation functionality in accordance with embodiments of the inventive disclosures made herein. Examples of such information translation functionality include translating information to different network communication protocols and translating information to a native language of a remote hardware domain from a native language of a local hardware domain.

Information passing arrangements in accordance with embodiments of the inventive disclosures made herein comprise the network drivers (225, 238) and the buffering devices (230, 240). Accordingly, a service processor hardware domain of the computer system 200 and an platform hardware domain of the computer system 200 both comprise physical layer network driver configured for facilitating communication between the two different hardware domains in accordance with the inventive disclosures made herein.

Such information passing arrangements do not require the need for any machine specific changes for enabling SNMP (Simple Network Management Protocol) monitoring via system management hardware (e.g., relatively low-level hardware that supports system management functionality). Furthermore, the network interface provided via the physical layer network drivers (225, 238) advantageously enables systems management software (i.e., running within the service processor hardware domain and which communicates with the components within the platform hardware domain) to issue system commands on behalf of the system management controller 235. Accordingly, the information passing arrangement enables system management software cause actions such as system shutdown or re-boot to be performed in a system friendly manner.

The network interface provided via the physical layer network drivers (225, 238) and the translation routine 245 of the network driver 225 also advantageously supports communication with the BIOS within the operating system platform. In one example, the translation routine 245 of the network driver within the service processor 205 detects information being sent to the BIOS, and converts that information into a protocol that BIOS can understand. This allows the BIOS to communicate during its early stages of operation, when it would otherwise be unable to formulate IP packets. Furthermore, because the packets are translated into UDP/IP packets, those packets can then be sent to multiple monitoring applications (e.g., running on the monitoring application system 215, which are capable of standard socket communication.

The physical layer network drivers (225, 238) that have the translation routines (245, 250) running respectively thereon are configurable with different source and destination addresses used within the IP protocol. This allows the translation routines (245, 250) to change the address and port numbers that BIOS communicates with. Additionally, communication with BIOS in this manner enhances the ability of system management software to upload diagnostic software onto the operating system platform, and then monitor that diagnostic software.

Accordingly, information passing arrangements in accordance with embodiments of the inventive disclosures made herein enable the BIOS to communicate with a variety of monitoring programs in a well-established protocol. This precludes the need for applications to be written in a manner where they must rely on one application to forward the BIOS messages to another application. Furthermore, because the communication is now facilitated via an IP packet, the applications that are communicating with the BIOS do not need to be physically connected with a local system (i.e., within which the BIOS persists), but rather be associated with a remote apparatus.

Such an approach to communicating information associated with BIOS allows applications that remotely (i.e., via a service processor) monitor and/or interact with the BIOS to be developed and implemented. Additionally, development of new applications that communicate with the BIOS will be more simple and faster because the communication happens over a standard UDP/IP communication interface.

It will be appreciated that there is a dependency between an information passing layer (i.e., including the buffering devices) and a network interface layer as disclosed herein. The service processor side software does not know the hardware-level protocol for communicating through the information passing arrangement. The service processor side software treats the communication path to the operating system platform as just another network interface. However, at service processor initialisation time, a mapping between the JNET network interface and the device driver providing the information passing arrangement is performed. Subsequently, the service processor side software (besides just the associated driver) never treats that network interface as anything other than a normal and/or generic network interface.

The following definitions are not intended to be limiting, but are provided to aid the reader in properly interpreting the detailed description of the present invention. It will be appreciated that a judge or jury may eventually interpret the terms defined herein, and that the exact meaning of the defined terms will evolve over time. The word “module” as used herein refers to any piece of code that provides some diagnostic functionality. Some examples of modules as used herein include device drivers, command interfaces, executives, and other applications. The phrase “device drivers,” as used herein and sometimes referred to as service modules, refers to images that provide service to other modules in memory. A driver can “expose a public interface,” that is, make available languages and/or codes that applications use to communicate with each other and with hardware. Examples of exposed interfaces include an ASPI (application specific program interface), a private interface, e.g., a vendor's flash utility, or a test module protocol for the diagnostic platform to utilize. The word “platform” as used herein generally refers to functionality provided by the underlying hardware. Such functionality may be provided using single integrated circuits, for example, various information processing units such as central processing units used in various information handling systems. Alternatively, a platform may refer to a collection of integrated circuits on a printed circuit board, a stand-alone information handling system, or other similar devices providing the necessary functionality. The term platform also describes the type of hardware standard around which a computer system is developed. In its broadest sense, the term platform encompasses service processors that provide diagnostic functionality, as well as processors that provide server functionality. The word “server” as used herein refers to the entire product embodied by the present disclosure, typically a service processor (SP) and one or more processors. In an embodiment, the one or more processors are AMD K8 processors, or other processors with performance characteristics meeting or exceeding that of AMD K8 processors.

Referring now to computer readable medium in accordance with embodiments of the disclosures made herein, methods, processes and/or operations as disclosed herein for enabling disclosed system management functionality are tangibly embodied by computer readable medium having instructions thereon for carrying out such methods, processes and/or operations. In one specific example, instructions are provided for carrying out various methods, processed and/or operations associated with the arrangement depicted in FIG. 1 and/or associated with the system depicted in FIG. 2. The instructions may be accessible by one or more processors (i.e., data processing devices providing service processor functionality) of a system as disclosed herein (i.e., a server) from a memory apparatus of the computer system (e.g. RAM, ROM, flash memory, virtual memory, hard drive memory, etc). Examples of computer readable medium include a compact disk or a hard drive, which has imaged thereon a computer program adapted for carrying out disclosed system management functionality.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical, chemical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. An apparatus, comprising:
a service processor hardware domain;
a platform hardware domain communicatively coupled to the service processor hardware domain; and
an information passing arrangement provided between the service processor hardware domain and the platform hardware domain, wherein the information passing arrangement is configured for enabling information to be transferred between the service processor hardware domain and the platform hardware domain.

2. The computer system of claim 1 wherein:
the information passing arrangement includes a plurality of buffering devices coupled between the service processor hardware domain and the platform hardware domain;
a first one of said buffering device is configured for buffering information to being transmitted from the service processor hardware domain for reception by the platform hardware domain; and
a second one of said buffering device is configured for buffering information being transmitted from the platform hardware domain for reception by the service processor hardware domain.

3. The computer system of claim 2 wherein:
the service processor hardware domain includes a first physical layer network device;
the operating platform hardware domain includes a second physical layer network device; and
the first and second physical layer network devices each provide a network interface for a respective one of said hardware domains, thereby enabling asynchronous transfer of information between said hardware domains.

4. The computer system of claim 3 wherein the information passing arrangement includes a translation routine configured for translating information from a format interpretable within the service processor hardware domain to a format interpretable within the platform hardware domain, wherein the translation routine is comprised by the first physical layer network device of the service processor hardware domain.

5. The computer system of claim 4 wherein the translation routine is further configured for formatting said information into a message having a transmission protocol enabling transmission of the message over the network interface of one of said hardware domains.

6. The computer system of claim 4 wherein the information passing arrangement facilitates access of registers of at least one of said buffering device for enabling information to be transferred between the service processor hardware domain and the platform hardware domain.

7. The computer system of claim 2 wherein each one of said buffering devices is a first-in first out buffering device configured for operation in accordance with data available and acknowledge interrupts.

8. The computer system of claim 1 wherein:
the service processor hardware domain includes a first physical layer network device;
the operating platform hardware domain includes a second physical layer network device; and
the first and second physical layer network devices each provide a network interface for a respective one of said hardware domains, thereby enabling asynchronous transfer of information between said hardware domains.

9. The computer system of claim 8 wherein the information passing arrangement includes a translation routine configured for translating information from a format interpretable within the service processor hardware domain to a format interpretable within the platform hardware domain, wherein the translation routine is comprised by the first physical layer network device of the service processor hardware domain.

10. The computer system of claim 9 wherein the translation routine is further configured for formatting said information into a message having a transmission protocol enabling transmission of the message over the network interface of one of said hardware domains.

11. The computer system of claim 1 wherein the information passing arrangement facilitates access of registers of at least one of said buffering device for enabling information to be transferred between the service processor hardware domain and the platform hardware domain.

12. A method for facilitating information transfer between a plurality of hardware domains within a computer system, comprising:
translating information to a format interpretable by a remote hardware domain from a format native to a local hardware domain, wherein said translation is performed within the local hardware domain;
queuing said information in a buffering device of the local hardware domain after performing said translating; and
transmitting said information from the buffering device of the local hardware domain for reception by the remote hardware domain after queuing said information.

13. The method of claim 12 wherein:
the local hardware domain is a service processor hardware domain;
the remote hardware domain is a platform hardware domain;
said information is translated into a protocol interpretable by a BIOS of the platform hardware domain in response to determining that said information is intended to be transmitted for reception by the BIOS of the platform hardware domain.

14. The method of claim 13, further comprising:
formatting said information into a message having a transmission protocol enabling transmission of the message over a network interface of one of said hardware domains.

15. The method of claim 12, further comprising:
formatting said information into a message having a transmission protocol enabling transmission of the message over a network interface of one of said hardware domains.

16. The method of claim 15 wherein:
the local hardware domain is a service processor hardware domain;
the remote hardware domain is an platform hardware domain; and
said information is formatted for initiating a system action within the platform hardware domain.

17. A server, comprising:
at least one data processing device;
instructions processable by said at least one data processing device; and
an apparatus from which said instructions are accessible by said at least one data processing device;
wherein said instructions are configured for enabling said at least one data processing device to facilitate:
translating information to a format interpretable by a remote hardware domain from a format native to a local hardware domain, wherein said translation is performed within the local hardware domain;
queuing said information in a buffering device of the local hardware domain after performing said translating; and
transmitting said information from the buffering device of the local hardware domain for reception by the remote hardware domain after queuing said information.

18. The server of claim 17 wherein:
the local hardware domain is a service processor hardware domain;
the remote hardware domain is a platform hardware domain;
said information is translated into a protocol interpretable by a BIOS of the platform hardware domain in response to determining that said information is intended to be transmitted for reception by the BIOS of the platform hardware domain.

19. The server of claim 18 wherein said instructions are further configured for enabling said at least one data processing device to facilitate:
formatting said information into a message having a transmission protocol enabling transmission of the message over a network interface of one of said hardware domains.

20. The server of claim 17 wherein said instructions are further configured for enabling said at least one data processing device to facilitate:
formatting said information into a message having a transmission protocol enabling transmission of the message over a network interface of one of said hardware domains.

21. The server of claim 20 wherein:
the local hardware domain is a service processor hardware domain;
the remote hardware domain is a platform hardware domain; and
said information is formatted for initiating a system action within the platform hardware domain.
